(19) United States
(12) Patent Application Publication
(10) Pub. No.: US 2007/0266271 A1
(43) Pub. Date: Nov. 15, 2007

(54) Error Response By a Data Processing System and Peripheral Device

(75) Inventor: Justin Frints, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,784

(22) PCT Filed: Aug. 2, 2005
(86) PCT No.: PCT/IB05/52579

§ 371 Date: Feb. 16, 2007

(30) Foreign Application Priority Data
Aug. 20, 2004 (EP) 04104005.6

(51) Int. Cl. G06F 11/07

(52) U.S. Cl. 714/44

(57) ABSTRACT

In a computer system a peripheral device executes commands that are issued by a main processor. The peripheral device executes the command and detects whether an error occurs during execution of the command. If so, the peripheral device transfers an error response program from the peripheral device (104) to the processor (100) and causes the processor (100) to execute the error response program. When the peripheral device (104) is arranged to provide the processor (100) access to an exchangeable data carrier (26), the peripheral device (104) generates signals that simulate to the processor (100) in response to detection of the error, that a data carrier is inserted in the peripheral device (104). In this case the peripheral device returns the error response program from a program memory (22a) in the peripheral device in response to a read command or commands from the processor (100) to read a program from the simulated data carrier.

The invention relates to a data processing system that comprises a programmable data processor connected to a peripheral device. More specifically the invention relates to the handling of errors in such a data processing system.

US patent application 2002/0099983 describes automated error reporting by a mobile telephone. The mobile telephone contains a processor that executes a program. When an error is detected during execution of the program an error report is generated and the report is transmitted to the manufacturer.

U.S. Pat. No. 6,687,749 describes a computer that uses automatic data collection to send an error report to a support centre. This method of reporting errors is proposed to replace the procedure wherein a user has to inspect his or her PC to collect error data that is needed for a report to the support centre. The patent describes that the computer uses device driver programs to make IO devices report status information that the computer includes in the error report. Different error reports may be generated for different application programs of the computer. For this purpose the patent proposes a plurality of software structures called “support channels” for respective application programs. The support channel for an application program and related information files are supplied by the vendor of the application program in the form of a “cabinet file”. The patent does not explicitly describe how the “cabinet files” are loaded but from the context it is clear that conventional techniques are used, such as downloading via the Internet, or loading from an installation disk.

Errors can occur not only in application programs but also in peripheral devices, which are typically IO devices such as disk drives, memory cards, video interfaces etc. Reporting of such errors is not addressed in the cited documents, but it can be realized in the same way as reporting of errors in application programs, i.e. by making the processor run an error-reporting program that gathers error data from an IO peripheral device when an error has occurred. Since the nature of errors is typically specific to the way the peripheral device is implemented, this error-reporting program will have to be aware of the version of the peripheral device that is installed. Especially in open environments such as PC's, where peripheral devices from many different vendors can be used, specific error reporting programs will be needed.

A disadvantage of this approach is that a device specific error-reporting program has to be provided for execution by the processor. This program has to be installed in advance, typically when the peripheral device is installed. This complicates distribution and installation of peripheral devices.

Among others it is an object of the invention to make it possible to respond to errors in a peripheral device of a computer system without requiring a separate error-response program to be installed before the error occurs. More particularly it is an object of the invention to make it possible to run an error-reporting program without requiring the error-reporting program to be installed before the error occurs.

The peripheral device according to the invention is set forth in claim 1. According to the invention the peripheral device itself is provides with a memory that contains an error response program. The peripheral device supplies the error response program to the programmable processor and causes the programmable processor to execute the error response program when the peripheral device detects an error. In this way the initiative to respond to errors, for example by sending a report about the circumstances wherein the error occurred, is taken by the error reporting device itself and no separate installation of an error reporting program is needed.

In one embodiment a “virtual disk” technique is used to start the error response program. The “virtual disk” technique is described per se in a co-pending patent application by the same assignee and unpublished at the priority date of the present application (applicants reference PHNL 040174EPP).

This technique applies to computer systems with an “autorun” feature, which causes a program from a specifically named file from a disk to be executed once the disk is inserted in the computer system. According to the virtual disk technique the disk drive simulates insertion of a disc, supplying an autorun file from a local memory, when the disk drive wants the computer system to start a specific action. Advantageously, this may be used to cause an error reporting program to be executed.

These and other objects and advantageous aspects of the invention will be illustrated by means of non-limiting examples that are described using the following figures.

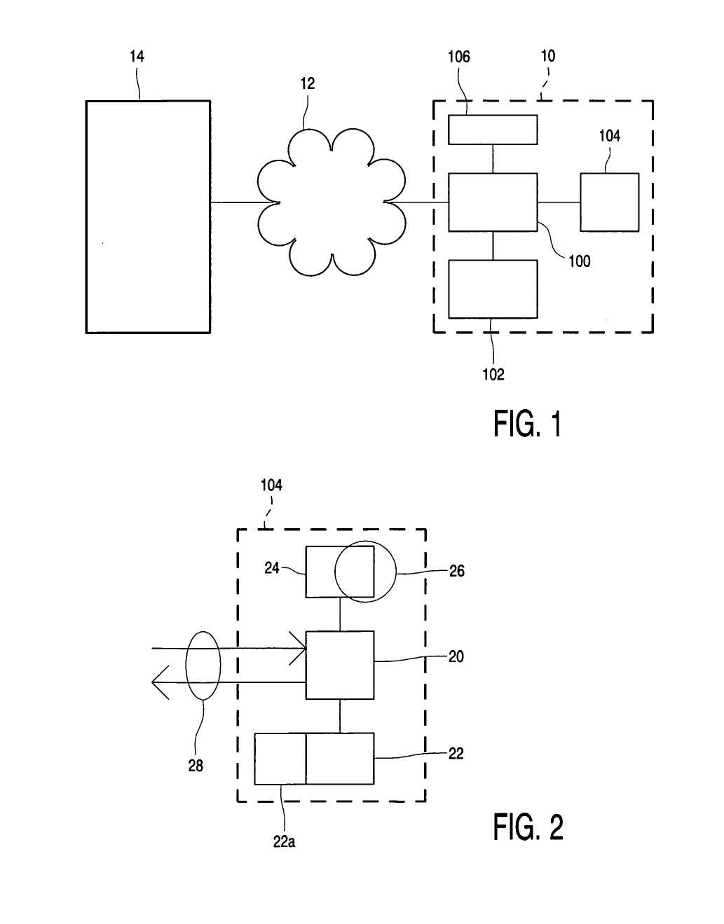

FIG. 1 shows a network environment

FIG. 2 shows a disk drive device

FIG. 1 shows a network environment comprising a user computer system 10 and a vendor system 14 interconnected by a network 12. User computer system 10 comprises a processor 100 coupled to a system memory device 102, a peripheral device 104 and a user interface 106.

A peripheral device, as the term is used herein, refers to a device that executes commands that a processor 100 issues during the course of program execution by processor 100 and accepts or returns data in response to at least some of the commands. Other than such response data the peripheral device typically at most communicates to processor 100 by generating request signals, such as interrupts and/or attention signals that inform processor 100 of a request, but leave it to the processor 100 to decide when and how it will respond to the request. Typically, a peripheral device acts as a slave device of the processor, the peripheral device returning, after substantially every action, to a “wait for command” state, wherein the peripheral device is ready to accept a command from the processor. Typically the peripheral device supports a predetermined set of commands from the processor.

A command from the processor to the slave peripheral device may take any form, such as for example that processor 100 writes command data to an address that is associated with the peripheral device. To write and read data processor 100 typically reads or writes data at the same or another address that is associated with the peripheral device, but alternatively DMA techniques may be used, wherein peripheral device 104 writes or read data directly to or from processor memory in response to the commands.

FIG. 2 shows a disk drive device as an example of peripheral device 104. The disk drive device contains an embedded processor 20 coupled to a firmware memory 22, drive actuators and sensors 24 and an interface 28 to processor 100 (not shown). A disk 26 is symbolically shown inserted in the disk drive.

In operation processor 100 executes programs of instructions, which are loaded for example from memory device 102, which is for example a hard disk drive or a semi-conductor memory. This is done for example under control of user interface 106. As a result of the instructions processor 100 sends I/O commands to peripheral device 104 and receives data form peripheral device 104 and/or sends to data to peripheral device 104.

In normal operation embedded processor 20 receives the commands from processor 100 and controls the drive actuators and sensors 24 according to these commands. Typically, execution of a command involves loading instructions that are associated with the command from firmware memory 22 and executing these instructions to perform specific actions with drive actuators and sensors 24. As a result of the operations information is read from disk 26 and embedded processor 20 returns data that is derived from that information to processor 100. Other commands may involve queries to which embedded processor 20 generates responses, status update instructions or write operations. In addition to responding to commands embedded processor 20 may also be arranged to execute selected instructions in response to external events such as activation of a control button (not shown) on the drive or pushing of the disk tray.

When embedded processor 20 detects an error during execution of the commands embedded processor 20 it stores information about the error. Preferably, embedded processor is also arranged to store information about errors that occur at other times, for example during execution of a program in response to an external event, and/or errors that are detected separate from program execution.

Optionally, embedded processor switches to an error report state. In response to entering the error report state embedded processor 20 sends instructions of an error-reporting program to processor 100 and embedded processor 20 causes processor 100 to execute that error-reporting program (in any order: the signal to execute the program may precede the sending of the program).

In response to entering the error report state embedded processor 20 executes an embedded program that results in sending a signal to processor 100 that signals insertion of a new disk 26 (although in fact physically no new disk 26 may have been inserted). In response processor 100 sends a command to read an autorun file with a predetermined filename from disk 26. When embedded processor 20 is in the error report state it monitors the commands from processor 100 to detect the command or commands that would result in loading the content of the autorun file. In response to this command or commands embedded processor returns file data from a part 22a of firmware memory 22. To processor 100 it appears as if this file has been retrieved from disk 26. Processor 100 executes instructions from this file. The execution causes processor 100 to send an error report with the information about the error to vendor system 14 via network 12.

This may be implemented for example so that embedded processor 20 returns the simulated content of the autorun file in response to the first commands issued by processor 100 to access a file, or in response to commands to access specific predetermined disk addresses where such an autorun file is expected to be stored. In another embodiment embedded processor 20 is implemented to monitor whether commands from processor 100 seek to access a file access table to find disk addresses of blocks of a file with the specific name for autorun, the embedded processor 20 returning simulated addresses, and subsequently blocks of the file from the firmware memory, when commands to read from these addresses are received.

It should be appreciated that the use of an autorun file for this purpose is only an advantageous embodiment, which makes it possible to cooperate with a processor 100 that need not have any specific error reporting facilities. Other mechanisms may be used to supply the error reporting program from peripheral device 104 to processor 100 and to make processor 100 execute that error reporting program. For example, the peripheral device may have a connection to processor 100 to submit the program at an input of processor 100 from which processor 100 normally reads programs, e.g. from the user interface 106, from the network 12 or from memory device 102. In this case peripheral device 104 may submit the error-reporting program at that input. In another example processor 100 may be arranged to support a special error mode wherein it loads and executes programs from peripheral device 104, the peripheral device 104 sending a signal to processor 100 to switch to the error mode upon detection of an error.

Various methods may be used to collect error information and to transmit that error information to vendor system 14. In one example embedded processor 20 copies information about the nature of the error to an error memory area for error report information. In addition local embedded processor 20 may copy state information, which it normally uses during execution of the commands, to the error memory area. Furthermore embedded processor 20 may copy sensor data to the error memory area. As an alternative this type of information may automatically be written during normal execution, the embedded processor 20 responding to the error merely by setting a flag that the information may not be overwritten. Alternatively a dedicated error handling circuit (not shown) may be included in peripheral device 104 to perform these or other actions in response to detection of an error.

Embedded processor 20 may trigger processor 100 to start executing the error-reporting program immediately upon detection of the error. However, this is not necessary. In an embodiment embedded processor first handles the error (for example by breaking of an I/O action and/or by resetting local state information and/or by returning a normal error signal to processor 100). In this case supply of the error reporting program and/or the start of its execution is delayed until after the error has been handled and processor 100 has returned to normal operation. Supply of the error-reporting program and/or the start of its execution may even be delayed until processor 100 has completed its current operation.

The error reporting program that peripheral device 104 supplies to processor 100 may be a standard error reporting program (independent of the error) for the peripheral device 104. In this case the error reporting program includes instructions to generate peripheral device specific commands to read error data from the peripheral device, e.g. from the error memory area where error information has been written. After the information has been read any flag that prevents the information from being overwritten may be cleared. In an embodiment embedded processor 100 supplies error information from the error memory area as a simulated disk file. In this case no special commands are needed to read the error information. The error-reporting program merely causes processor 100 to issue a command or commands to read a specific file. Embedded processor 20 monitors whether this command or these commands are issued and, if so, supplies the error information from the error memory area instead of from the disk. Thus a virtual disk is simulated.

As an alternative, peripheral device 104 may supply a dedicated error-reporting program to processor 100, the peripheral device 104 inserting information about the error (for example a copy of the information in the error memory area) in the error-reporting program that it supplies to processor 100. In this case processor 100 need not access the peripheral device 104 during execution of the error-reporting program, which considerably simplifies the error report operation, and obviates the need for dedicated commands to read error data from peripheral device 104.

Once processor 100 executes the error-reporting program, processor 100 may automatically transmit the error report to vendor system 14, but alternatively the error-reporting program causes processor 100 to prompt the user for permission via user interface 106.

Although the invention has been described for a specific embodiment it should be understood that the invention is not limited to this embodiment. For example, instead of an error reporting program any other type of error handling program may be used, for example a program to download new firmware into peripheral device 104 from network 12 if it is found that the error is due to a firmware error. However, firmware updates can of course also be downloaded once they are made available from vendor system, i.e. in response to a signal from the vendor system or a signal from the user interface and not at the initiative of the peripheral device. It should be understood that the invention is especially advantageous for error reporting because errors are most readily detected in the peripheral device and the method is capable of getting the error reported without external support.

Furthermore, it should be understood that different hardware configurations may be used. For example, a plurality of processors 100 may be used in computer system 10. In this case peripheral device may cause any processor to execute the error response program, not necessarily the processor that issued the command that lead to the error. Similarly, although preferably embedded processor 20 executing a program from firmware memory 22 functions as error response circuit, a separate error response circuit may of course be provided, which need not itself be programmable. In fact the peripheral device need not contain a programmable embedded processor 20 at all, or this processor may be of a very simple type that is not capable of executing the error-reporting program, even if it had direct access to network 12. Furthermore, although use of a network 12 has been shown, it should be understood that other communication means may be used. Typically, the peripheral device is of such a simple nature that it has no direct access to these communication means. Vendor system 14 may be replaced by any system that is arranged to receive and register error reports.

1. A peripheral device (104) for use in a computer system (10) wherein a computer system (10) issues a command to the peripheral device (104) to perform a peripheral operation, the peripheral device (104) comprising
an interface (28) for connection to the computer system;
a program memory (22a) wherein an error response program is stored,
an error response circuit (20) arranged to transfer the error response program to a programmable processor (100) of the computer system via the interface (28), upon detection of an error in the execution of the command, and to cause the programmable processor (100) to execute the error response program.

2. A peripheral device (104) according to claim 1 which is arranged to provide the processor (100) access to an exchangeable data carrier (26), the error response circuit (20) being arranged to generate a signal, of a type that is normally indicative of insertion of a data carrier, to the processor (100) in response to detection of the error, and to return the error response program from the program memory (22a) simulating reading of data from the data carrier in response to a read command or commands from the processor (100) to read a program from the data carrier.

3. A peripheral device according to claim 1, wherein the error response program is arranged to cause the processor (100) to send an error report to a vendor system (14) via a network (12).

4. A peripheral device according to claim 1, wherein the error response circuit (20) is arranged to include information that identifies the error and/or information about a state of the peripheral device (104) when the error occurred with the error response program when the error response program is transferred.

5. A peripheral device according to claim 1, wherein error response circuit (20) is arranged to keep stored information that identifies the error and/or information about a state of the peripheral device (104) when the error occurred in the peripheral device (104), the error response program being arranged, when executed by the processor (100), to cause the processor (100) to read said information from the peripheral device (104).

6. A data processing system (10), comprising a programmable data processor (100) and at least one peripheral device (104) according claim 1, coupled to the programmable processor (100) for performing a peripheral operation upon a command from the programmable processor (100).

7. A method of operating a peripheral device in a computer system (10), the method comprising
sending a command in the computer system to a peripheral device (104);
executing the command in the peripheral device (104);
detecting whether an error occurs during execution of the command, and, if so, in response to detection of the error:
transferring an error response program from the peripheral device (104) to a programmable processor (100) of the computer system (10);
causing the programmable processor (100) to execute the error response program.

8. A method according to claim 7 wherein the peripheral device (104) is arranged to provide the processor (100) access to an exchangeable data carrier (26), the method comprising
generating a signal from the peripheral device (104) to the processor (100) in response to detection of the error, the signal being of a type that is indicative of insertion of a simulated data carrier in the peripheral device (104);
returning the error response program from a program memory (22a) in the peripheral device in response to a read command or commands from the processor (100) to read a program from the simulated data carrier.

9. A method according to claim 7, comprising using the error response program to cause the processor (100) to send an error report to a vendor system (14) via a network (12).

10. A method according to claim 7, comprising including information that identifies the error and/or information about a state of the peripheral device (104) when the error occurred with the error response program when the error response program is transferred.

11. A method according to claim 7 comprising
preserving information that identifies the error and/or information about a state of the peripheral device (104) when the error occurred in the peripheral device (104),
using the error response program to cause the processor (100) to read said information from the peripheral device (104).
